(19) United States
(12) Patent Application Publication
(10) Pub. No.: US 2010/0090138 A1
(43) Pub. Date: Apr. 15, 2010

(54) VALVE

(76) Inventor: Andre Bromley, Warwickshire (GB)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/513,239

(22) PCT Filed: Nov. 2, 2007
(86) PCT No.: PCT/GB2007/004195

§ 371 Date: Dec. 2, 2009

Related U.S. Application Data
(60) Provisional application No. 60/861,199, filed on Nov. 27, 2006.

(30) Foreign Application Priority Data
Nov. 3, 2006 (GB) 0621953.9

(51) Int. Cl. F16K 31/08; F16K 23/00; B67D 7/54

(52) U.S. Cl. 251/65; 251/157; 141/208

(57) ABSTRACT

A nozzle (11), for example for a liquid fuel delivery system, has a shut-off valve (17) closed by a magnetic closing force. In the open condition the valve (17) moves against a closing spring (31); the magnetic force weakens as the spring force increases.

This invention relates to an automatic valve, and particularly to such a valve having a closure force applied by magnetic means.

In this specification, by automatic valve we mean a fluid flow valve having a closure member biased to the closed condition, but adapted to open in the event of a pre-determined pressure differential across the sealing face thereof. In such a valve the closure member typically moves with respect to a valve body and on application of a direct pressure differential thereto, for example an increase in pressure on the upstream side.

One example of an automatic valve is a poppet valve having a coil spring around the stem thereof and biasing the valve to the closed condition. On application of a suitable fluid force, the valve is forced open against the closing force to admit fluid under pressure to the downstream side thereof. Such valves are constructionally simple and reliable in use.

One disadvantage of a conventional valve having a spring closure is that the spring is under permanent load, and may relax over time when in the closed condition. If the closure force is reduced to lower the risk of relaxation, the sealing faces are less tightly engaged, and leaks may occur as a consequence.

Conversely, if the closure force is increased to better prevent leakage, the opening force is increased.

A particular example of an automatic valve is found in nozzles having a valve at the mouth thereof to prevent spillage and/or evaporation. Such nozzles are found at fuel filling stations, and it is desirable to close such nozzles when not in use, so as to eliminate dripping and evaporative losses of the fluid portion which is between the dispensing mechanism and the nozzle mouth.

Examples of non-drip nozzles are as follows:

U.S. Pat. No. 5,645,116 McDonald—non-drip liquid dispensing nozzle, but with a cumbersome and vulnerable external spring stopper at a nozzle outlet.

U.S. Pat. No. 5,620,032 Dame—retro-fit anti-drip nozzle valve for fuel dispensing nozzles using C-spring mounted rubber flap valves. These are insecure, fragile and vulnerable to interference.

U.S. Pat. No. 6,520,222 Carmack et al—vapour assisted fuel dispensing nozzle with interconnected spring biased poppet regulator valve and recessed ball valve at discharge end.

U.S. Pat. No. 4,331,187, U.S. Pat. No. 3,648,894, U.S. Pat. No. 6,491,282 teach various liquid dispensing valve configurations with refinements such as flow anti-shock conditioning.

WO 02/087969 and WO 03/010022 teach fuel dispensing nozzle elaboration respectively with interactive user interface and shroud interaction with a fuel tank filler neck.

DE 29516051 (Ehlers)—nozzle drip inhibitor with spring-biased stopper toward nozzle tip, to allow liquid through-flow only upon sufficient pressure.

FR 2714900 (Elf)—nozzle drip inhibitor, with spring-biased stopper toward nozzle base, to allow liquid through-flow only upon sufficient pressure.

U.S. Pat. No. 5,377,729 (Reep)—nozzle drip inhibitor, with spring-biased stopper stem supported by fixed stand toward nozzle tip.

According to the invention there is provided an automatic valve for a fluid flow conduit, said valve comprising a valve body having a movable valve member therein, and a spring to bias said valve member towards the closed condition, wherein the valve member and body include magnets, the poles of said magnets being opposed and offset in the closed condition of the valve member to exert a closing force thereon.

Such an arrangement allows a significant magnetic closing force in the closed condition of the valve member in conjunction with minimal spring closing force. The problem of spring relaxation in use is thus substantially mitigated.

The poles of the magnets may be N-N or S-S, and the power and offset selected to ensure an adequate closing force having regard to the circumstances of use. The adjacent poles are preferably exposed so as to give unattenuated repulsion force.

Button magnets or annular magnets may be used, preferably permanent magnets. In case of button magnets, it is preferable to arrange them so that no net lateral force is exerted on the valve member. For example the magnets may be arranged oppositely, or in a circular array. Annular magnets are preferably co-axial.

In a preferred embodiment the valve member is movable axially of the conduit, and the magnets are offset about a plane perpendicular to the axis of movement.

It will be appreciated that as the valve member moves away from the closed condition, the magnetic closing force reduces quickly to zero, and then acts oppositely to urge the valve member further open. The conventional return spring is however arranged to be sufficient to overcome such magnetic opening force, which in any event diminishes rapidly as the magnets separate.

In a preferred embodiment the valve member is a poppet valve having a coil compression spring providing a closure force thereon. The coil spring is preferably located about a stem of the poppet valve, said stem being guided in journals of the valve body.

A poppet valve can be located at the mouth of a filling nozzle so as to minimize any potential undrained volume after cessation of fluid flow.

Other features of the invention will be apparent from the following description of a preferred embodiment shown by way of example only with reference to the accompanying drawings, in which:

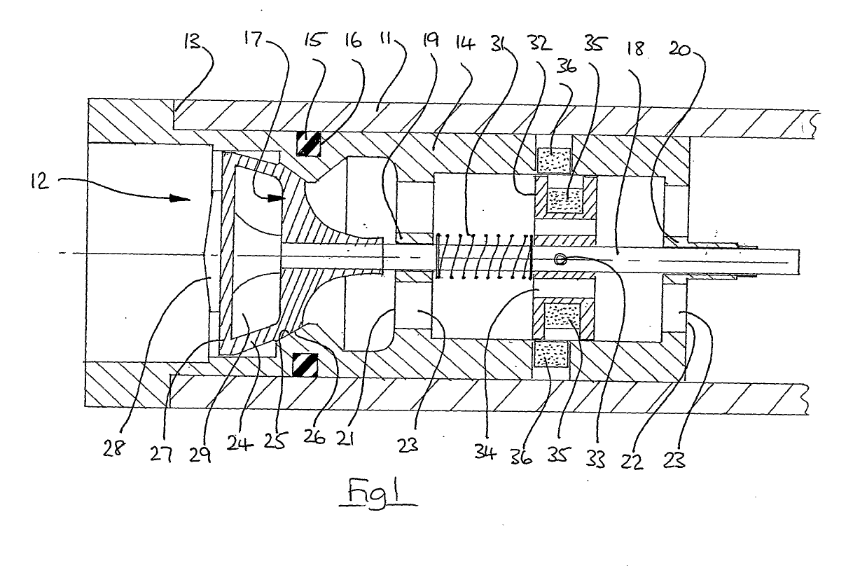

FIG. 1 is a schematic axial cross-section through a valve according to the invention.

FIG. 2 illustrates typical force/displacement characteristics of the coil spring and magnets of FIG. 1.

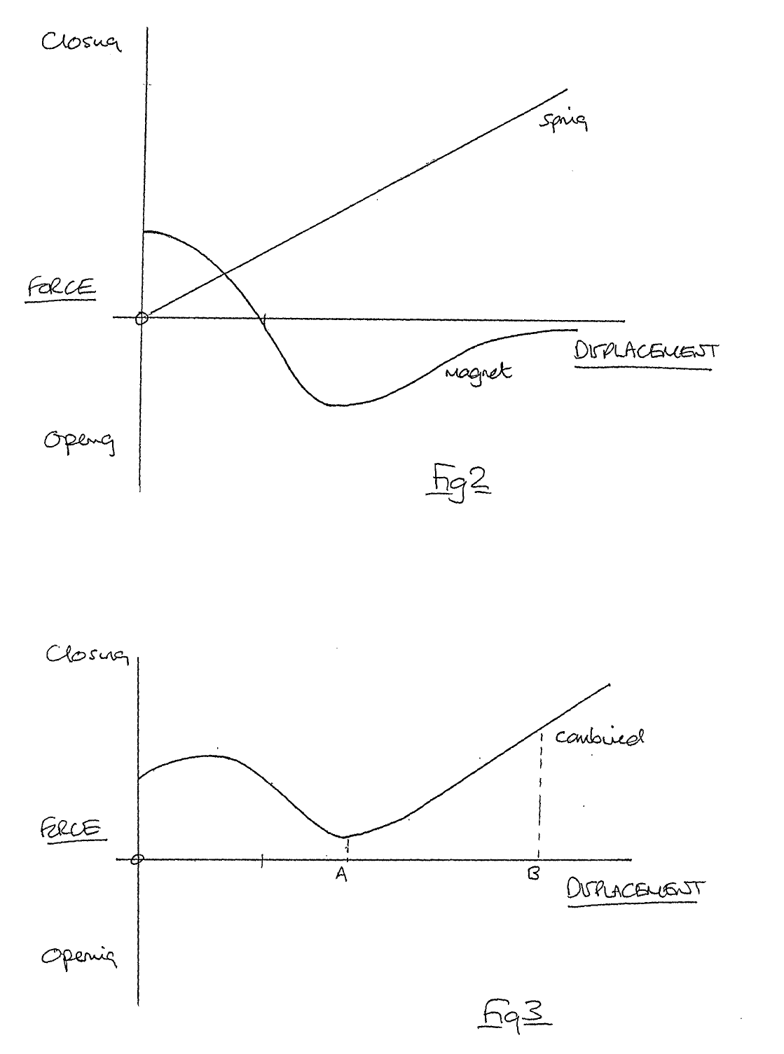

FIG. 3 illustrates a typical combined force/displacement characteristic, corresponding to FIG. 2.

An embodiment of the invention is illustrated in FIG. 1.

A fuel delivery nozzle 11 comprises a generally tubular spout of non-ferrous metal. A return passage (not shown) may be included within the wall thereof, and for causing cessation of flow in the event of a fuel blow-back.

A valve assembly 12 comprises a close fitting insert for the mouth of the nozzle, and includes a shoulder 13 for abutment with the nozzle end. The assembly 12 includes a generally tubular body 14 having an annular seal 15 located in an external groove 16, and for sealing the body against the inner surface of the nozzle 11.

The body 14 defines a through passage for fuel within which is located a spring loaded poppet valve 17.

As illustrated, the valve 17 comprises a stem 18 on the central axis of the body 14 and journalled in cylindrical bearings 19,20 supported by radial arms 21,22. These arms define through apertures 23 of suitable size and shape for permitting flow of fuel.

A tulip head 24 is attached to the stem and defines an annular seat 25 for co-operation with a corresponding annular seat 26 of the body 14. The mouth of the tulip head 24 is closed by a circular disc 27, and secured by a domed nut 28 engageable with a threaded end of the stem 18. Openings 29 are provided in the side wall of the tulip head 24 on the distal side of the seat 25, so that the tulip head volume is exposed to fuel flow in use.

A coil return spring 31 is located around the stem 18 and acts between the distal bearing 19 and a disc 32 of the stem. The disc 32 is fixed relative to the stem 18 by for example a roll pin 33 and is approximately midway between the bearings 19, 20.

The outer surface of the disc 32 is freely movable within the body 14, and the disc itself defines through passages 34 for the passage of fuel in use. As an alternative to the disc 32, radial arms could be provided, the through passages being defined between said arms.

Mounted at the outer edge of the disc are opposed button magnets 35 having poles at the radially inner and radially outer sides. Corresponding button magnets 36 are provided in the wall of the body 14, as illustrated.

In place of button magnets, suitable annular magnets could be provided, again with poles at the radially inner and radially outer sides.

For reasons which will become apparent the poles of magnets 35,36 are arranged to be opposed—that is to say that the adjacent poles are of the same kind, and thus the magnets repel each other.

As illustrated the magnets 35,36 are arranged so that those on the stem 18 are proximal of those on the body 14. Accordingly it will be understood that the magnetic repelling force tends to close the poppet valve 17, and to keep it closed.

The valve assembly 12 is secured in the nozzle 11 by any suitable means. For example a grub screw in the wall of the body 14 may suffice. Alternatively a conventional internal snap ring may engage the assembly and nozzle when in the correct axial condition.

FIG. 1 shows the valve assembly 12 in the closed condition in which through flow of fuel is obstructed. The poppet valve 17 is closed against the seat 26 by virtue of magnetic repelling forces of magnets 35,36.

The closing force exerted by the spring 31 may be minimal or zero in the closed condition.

In the event that a differential pressure is applied at the upstream side of the nozzle, typically 20 psi, the poppet valve 17 is forced open against the magnetic repulsion force, and the return force developed in the spring 31. By virtue of the opening 29, fluid enters the tulip head and exerts an opening force on the disc 27. By virtue of the differential area, the poppet valve tends to ‘snap’ open to a predetermined extent, thus avoiding any tendency to open with minimal clearance at the seats 25,26.

In this condition the magnets 35,36 are substantially radially aligned so that there is no net magnetic force. Fuel flows through the nozzle at a predetermined low rate. A further increase in pressure at the upstream side results in an increased opening at the seats 35,36, and in consequence a full fuel flow. The closing force of the spring 31 is countered by the repelling force of the magnets 35,36, but the magnetic force weakens as the spring return force increases.

The effect is illustrated in FIGS. 2 and 3. In FIG. 2, the relative forces of spring and magnets are shown individually. Net force is illustrated in FIG. 3.

With reference to FIG. 2, the force/displacement characteristic of the coil spring is the usual straight line—thus closing force increases in proportion to compression thereof (within a normal operating range). The magnetic force is arranged to be at a maximum in the closed condition of the poppet valve 17, and reduces rapidly as the valve opens and the magnets become radially aligned. As the poppet valve continues to open, magnetic repulsion causes a strong opening force to be exerted, but as the magnets separate this opening force reduces. The maximum upstream pressure in a fuel nozzle is of the order of 45 psi.

The combined effect, as illustrated in FIG. 3 is of a strong magnetic closing force in the closed condition, with minimal spring closing force. With increasing displacement, the closing force falls to a minimum, thus ensuring rapid and positive opening of the poppet valve. Closing force then rises in accordance with the spring characteristic. The relative magnetic and spring closing forces can be arranged to give a desired overall characteristic. A suitable mechanical stop is typically incorporated to restrict maximum opening of the poppet valve, and to confine the spring to a linear range.

The low flow position, with magnets more or less aligned and balancing the spring closing force, can advantageously correspond to trickle flow condition of a petrol nozzle (see FIG. 3, point A). Full flow may correspond to a stop for the valve member (see e.g. FIG. 3, point B).

The magnetic force is developed independently of the spring force and thus the invention gives particular flexibility in setting a desired operation characteristic. The magnets are arranged to give no net lateral force on the moving valve member, so as to minimize the possibility of friction or stiction.

Application of the invention to a fuel flow nozzle is illustrated in FIGS. 4-6.

FIG. 4 shows a conventional nozzle 40 having a delivery valve 41 operated by a handle 42, and an open spout 43. Fuel 44 is maintained upstream of the valve 41 delivery hose 45.

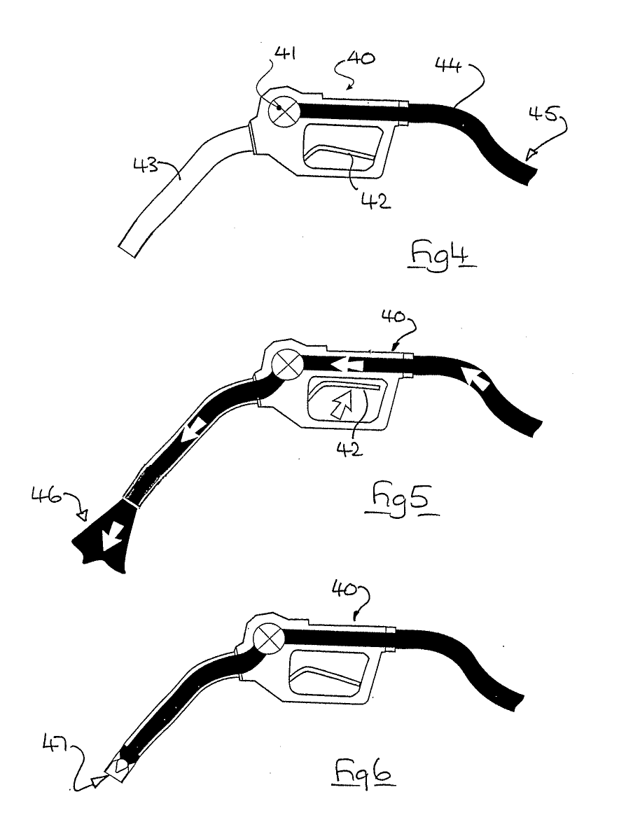

FIG. 5 shows the handle 42 in the open condition, with fuel flowing into a receptacle 46, which may be a fuel tank of a vehicle. It will be appreciated that when the delivery valve is closed, not all fuel may drain out of the nozzle spout 43 notwithstanding the efforts of the user.

FIG. 6 illustrates the effect of the invention, by which a shut-off valve 47 is located at the mouth of the nozzle to retain fuel therein. Each successive user is ensured correct metering because the same volume is consistently retained upstream of the shut-off valve.

Although this invention has been described in relation to a fuel flow nozzle, it is applicable to any kind of flowable substance, and to installation within a conduit rather than at the mouth of a nozzle.

1. A closure valve for a fluid flow conduit, said valve comprising a valve body defining the conduit, a movable valve member therein, and a spring to bias the valve member to a closed condition, wherein the valve member and body include magnets, the poles of the magnets being opposed and offset in the closed condition of the valve member to exert a closing force thereon.

2. A valve according to claim 1 wherein the magnets are permanent magnets.

3. A valve according to claim 2 wherein the magnets are button magnets.

4. A valve according to claim 2 wherein the magnets are annular.

5. A valve according to claim 1 wherein said body defines a flow axis, said valve member is movable on said axis and said magnets are offset about a plane perpendicular to said axis.

6. A valve according to claim 5 wherein said valve member is a poppet valve having a stem guided in said body, and said spring is located about said stem.

7. A valve according to claim 1 wherein in a first open condition of the valve member, said magnets exert neither a closing nor an opening force thereon.

8. A valve according to claim 7 wherein in a second open condition of the valve member, said magnets exert an opening force thereon.

9. A valve according to claim 1 wherein the adjacent poles of said magnets are exposed.

10. (canceled)
